(19) United States
(12) Patent Application Publication
(10) Pub. No.: US 2006/0041437 A1
(43) Pub. Date: Feb. 23, 2006

(54) Method and apparatus for windshield repair during vehicle servicing

(76) Inventors: Michael P. LaVigne, Lynnwood, WA (US); Lloyd D. Ryan JR., Lynnwood, WA (US)

Correspondence Address: Glenn P. Rickards;DOWREY RICKARDS PLLC, Suite 106, 19119 North Creek Parkway, Bothell, WA, 98011, US

(21) Appl. No.: 10/920,012

(22) Filed: Aug. 17, 2004

(51) Int. Cl. G06Q 99/00

(52) U.S. Cl. 705/1

(57) ABSTRACT

Automotive servicing, such as that offered by a lubrication center, and windshield repair may be conducted in parallel. The use of low-profile, integral windshield repair resin applicator and UV shield and self-powered, low-profile UV light source facilitate windshield repair without interfering with the performing of the vehicle servicing. Use of a self-powered rotary tool allows removal of glass chips from damaged windshield areas. Use of a probe to apply pressure to the damaged area facilitates avoiding entering into the vehicle. Providing windshield repair technicians or other personnel with insurance company automated telephone system dialing sequences to reach the proper extension and with scripts for providing windshield repair claim information speeds the insurance claim authorization request process. Windshield repair may be commenced while insurance claim authorization is pending.

### FIELD OF THE INVENTION

The present invention relates to the field of windshield repair.

### BACKGROUND OF THE INVENTION

In modem motor vehicles, the windshield glazing is typically a laminate of two glass layers bonded to an intermediate layer of a polymeric material. Many vehicles experience windshield damage from, for example, the impact of rocks and other road debris. The impact may cause various different types of damage, including “bullseyes,” in which the damage does not include cracking of the glass extending radially from the impact point, “stars,” that comprise such radially-extending cracks, and combinations that include both bulls-eye- and star-type damage. As a subset of star-type damage, single cracks may originate from an impact zone. Non-structural damage may include pitting or chipping of the windshield. Usually, the windshield damage is confined to the outer glass layer.

It is known in the art to repair windshield damage using a resin that cures and hardens in response to exposure to ultraviolet (“UV”) light. For bulls-eyes, stars and combination damage, prior art windshield repair methods have used a rotary tool with a small burr-type bit to remove small quantities of glass from the center of the impact, in part to improve penetration of the resin into the damaged area. The resin is then applied to the windshield, often under pressure, to aid in penetration of cracks in the glass. The damaged area of the windshield may also be heated to facilitate penetration of the resin into the cracks, and by flexing the windshield outward from the interior of the vehicle. Heating of the windshield may extend the repair process by 20 to 30 minutes, as time is required both for heating and cooling.

During the repair process, a UV shield is frequently used to prevent the premature curing of the resin. These shields have typically been rather large and awkward to work with, as they usually must be adapted to cover the rather large resin dispensing equipment currently in use. When the resin-application process is completed, the UV shield can be removed to allow either sunlight or UV light from a lamp to reach the windshield in order to cure the resin. Like the prior art UV shields, the lamps with their power cords are typically fairly large and awkward to work around.

Another aspect of the windshield repair process is arranging for payment for the windshield repair service. The cost of windshield repair is frequently borne by insurance companies. The repair process is frequently delayed by the need to obtain authorization from the insurance company or a contractor or agent, such as a glass claim administrator, prior to commencing repair in order to insure that payment for the windshield repair service will be forthcoming. If the claim is not authorized by the insurance company or contractor, the customer may then have to pay for the service. In this regard, it has become a practice of many insurance carriers to approve windshield repairs without application of any deductible that the insurance policy may have, although the practice is subject to certain restrictions and considerations.

It is known to repair windshields in connection with servicing of a motor vehicle. However, the repair process has had to be carried out before, after or between the other vehicle repair procedures in order to avoid interference between the windshield repair work and other vehicle servicing. This is due in part to the need for access to the vehicle. For example, windshield damage is located in the lower portion of the windshield. Bulky UV shields, resin applicators and lamps may interfere with the opening of the hood or the operation of other movable members adjacent the windshield. Thus, if the servicing of the vehicle requires the opening of the hood or the like, and if the profile of UV shields, applicators, lamps and the like or of power cords of windshield repair equipment would interfere with the raising of the hood, then neither the personnel servicing the vehicle nor the windshield repair personnel can work efficiently at the same time. Thus, typically, the vehicle servicing is performed at a separate time from the windshield repair.

Lubrication centers, or lube centers, have become commonplace in the United States of America, and windshield repair has been offered on-site at lube centers. However, owing to the nature of the lube center environment and process, the windshield repair and the vehicle servicing are performed sequentially, and frequently at different locations. This is due, in large part, to the rapid pace at which lubrication center services are performed. Customers take their cars to lube centers with the expectation that their vehicles can be serviced quickly without an appointment. In addition to changing the oil and oil filter, lube center services often include checking and replenishing of fluids, such as coolant, windshield washer solution and transmission fluids, checking and replacing air filters and the like. Many of these services must be performed with the hood of the car open so that the engine compartment is accessible. In addition, multiple service personnel may be present in the vicinity of the car during such service, and the vehicle may need to be moved between two or more stations during the service process.

Maintaining efficiency in a lube center environment is further complicated by the fact that customers often choose different subsets of the services offered. For example, one customer may only want an oil change, while another may request that the automatic transmission fluid also be changed. Likewise, one customer may not need replenishment of fluids, such as brake, automatic transmission, power steering or windshield washer fluid, while another may require that multiple types of fluids be replenished. This makes it difficult to orchestrate all of the services each customer may want in an expeditious manner. As a result, the lube center environment is typically very busy.

In order to keep up vehicle throughput and satisfy customers' demands for quick service, lube centers may track various operating parameters. Times such as start-to-finish, entry to service bay to exit therefrom, initial customer greeting to entry to service bay, entry to service bay to start or end of cash register ring-out and so forth. Goals of fifteen to twenty minutes for start-to-finish times and seven or 8 minutes for the time from bay entry to bay exit are desired.

### BRIEF DESCRIPTION OF THE INVENTION

In one aspect of the invention a method is provided for the rapid repair of windshields that can be integrated with other vehicle servicing. The windshield may be flexed from the vehicle exterior using a probe and/or material may be removed from a pit or other damage area using a self-powered rotary tool. A flexible UV shield may be mounted on a base on which a windshield repair resin applicator is mounted to provide UV shielding. A low-profile, self-powered UV source may be used for curing of the resin. In another aspect, windshield repair equipment having a low profile permits the opening of the hood and operation of other movable members of the vehicle without interference. Self-powered equipment may be used in the windshield repair to avoid the interference created by power cords in the vehicle service environment. In another aspect, a fee may be charged in connection with submission of a request for approval of a windshield repair claim and a liability waiver may be offered to windshield repair customers to reduce delays in the commencing of windshield repair. Windshield repair insurance claim authorization may be facilitated and speeded up by providing the repair personnel with insurance company specific dialing sequences to assist them in quickly navigating automated telephone systems used by many insurance companies. Insurance company specific scripts may also be provided to speed the process of presentation of claim authorization information to the insurance company.

### BRIEF DESCRIPTION OF THE DRAWINGS

FIG. 1 is a perspective view of a low-profile windshield repair apparatus with integral UV shield and with the resin applicator in a first position.

FIG. 2 is a perspective view of the windshield repair apparatus of FIG. 1 mounted on the windshield of a vehicle.

FIG. 3 is a perspective view of a low-profile UV light source mounted on the windshield of a vehicle.

FIG. 4 is a perspective view of the windshield repair apparatus of FIG. 1 with the resin applicator in a second position.

FIG. 5 is a bottom plan view of the windshield repair apparatus of FIG. 1.

FIG. 6 is an exploded view of a resin applicator.

FIG. 7 is a perspective view of the resin applicator of FIG. 1 with a right-angle resin applicator positioned in a second position.

### DETAILED DESCRIPTION OF EMBODIMENTS OF THE INVENTION

There are two basic kinds of automobile servicing. These are prearranged servicing and drop-in servicing. Major repairs, such as transmission and engine overhauls, are typically performed as prearranged service, whereas services such as oil changes and repair or replacement of tires are often performed as drop-in service.

Customers wishing to have service performed on a drop-in basis are frequently reluctant to agree to the performing of services additional to the principal service being sought if the additional services will result in additional waiting time. Windshield repair has thus not been cons

While the present invention may be used in environments other than a lube center environment, the invention will be illustrated and discussed herein using a lube center environment, as lube centers are a major venue for drop-in vehicle servicing.

Integrating windshield repair with drop-in servicing, such as that provided by a lube center, presents challenges in order to avoid requiring the customer to wait for an additional period for the completion of the vehicle servicing. In one embodiment, the integration of windshield repair and other servicing is aided by the use of low-profile windshield repair apparatus that can be mounted on the windshield.

In this context, “low-profile” means that, when the apparatus is mounted on a windshield, the upper portions thereof do not extend above the surface of the windshield to an extent that it interferes with the raising and lowering of the hood of the vehicle or other accessing of the parts of the vehicle by the lube center staff performing the lubrication and other services. Generally, apparatus having an overall height of not more than 7.5 cm (3 in.) may be considered as low profile.

The ideal apparatus for windshield repair in a lube center environment will also be quick and simple to position, mount and use. The footprint of the apparatus is also a consideration. It is less likely that apparatus with a small footprint will interfere with other lube center activities. Similarly, the likelihood that the apparatus will interfere with other lube center activities is reduced if the apparatus is self-powered so that it does not require a power cord or vacuum line.

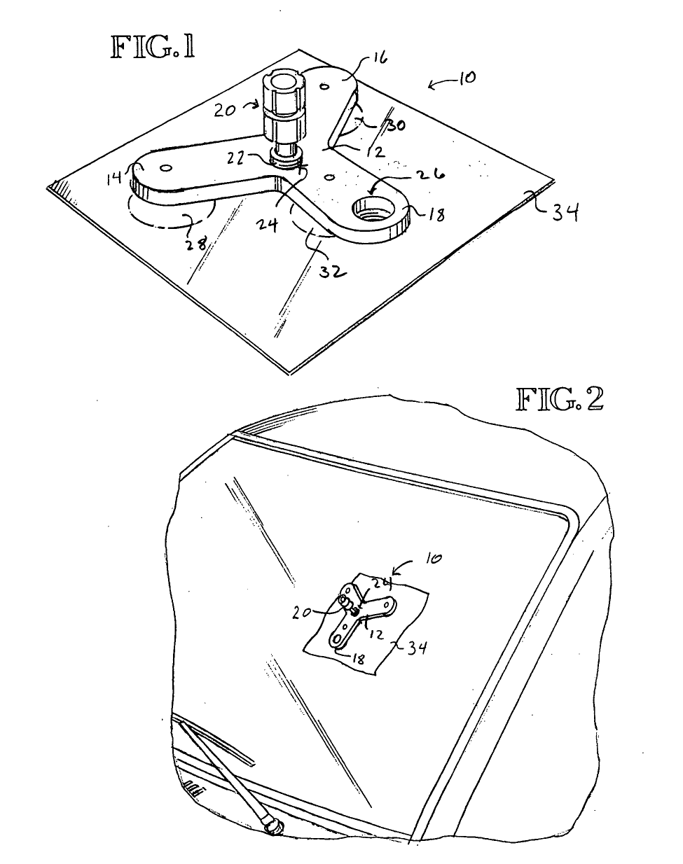

FIGS. 1 and 5 show one embodiment of such a low-profile windshield repair apparatus 10. The apparatus 10 comprises a Y-shaped base 12 having three arms 14, 16, 18. A resin applicator 20 having a threaded barrel 22 may be, in the alternative, screwed into a central aperture 24 in the base 12, or into a second aperture 26 adjacent the distal end of one of the arms 18.

In the present embodiment, suction cups 28, 30, 32 are mounted to the base by screws. A flexible UV shield is mounted beneath the base 12. Two of the suction cups 28, 30 are mounted adjacent the distal ends of the arms 14, 16, and the other suction cup 32 is mounted to the arm 18 inboard of the second aperture 26. In the present embodiment, the mounting screws for the suction cups extend through apertures in the UV shield 34, thus securing the UV shield to the base.

FIGS. 2 and 4 show the windshield repair apparatus 10 mounted on a vehicle windshield with the resin applicator 24 located, respectively, in the center aperture 24 and the aperture adjacent the distal end of the arm 18.

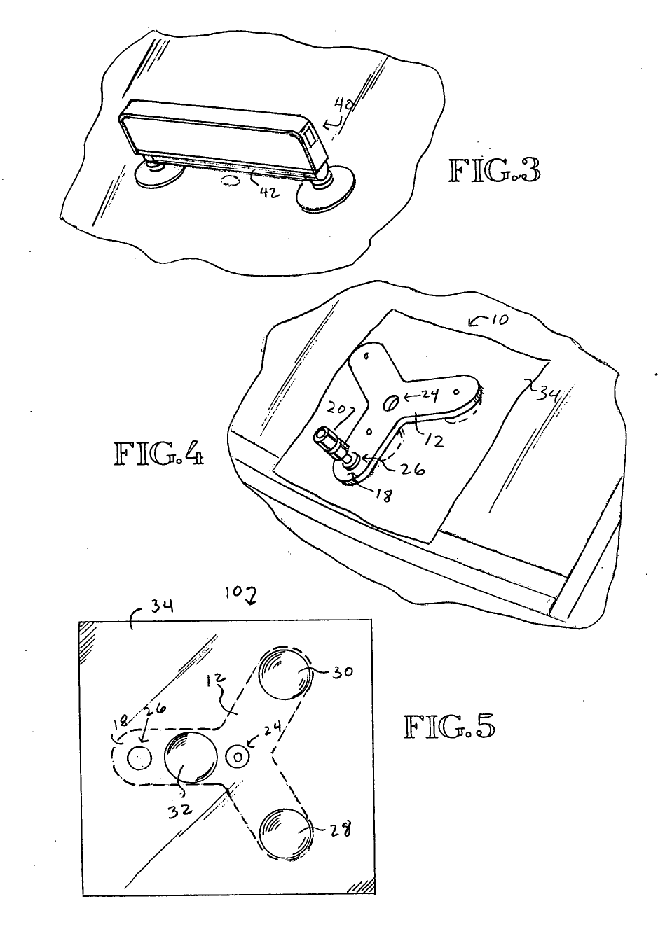

As shown in FIG. 3, a compact, battery-powered low-profile UV source 40 according to one embodiment of the invention may be provided. The UV source 40 comprises a fluorescent tube 42 mounted in a holder 44. Suction cups 46, 48 are mounted at either end of the holder such that, when mounted to a vehicle windshield, the fluorescent tube 42 is generally parallel to the windshield and is in close proximity thereto. The electronics that start and operate the fluorescent tube are contained within the handle, as are the batteries that power it.

Referring to FIG. 6, the resin applicator 20 of the present embodiment comprises a plunger 50, a body 52 and a seal 54. The plunger 50 comprises a cap 56 at one end and a threaded portion 58 intermediate the cap and a cylindrical section 60. The body 52 comprises a cap 62 and a threaded barrel 22.

The interior of the body 62 is threaded such that the threaded portion of the plunger 58 can be screwed into the barrel 22 of the body 52 to control the position of the cylindrical portion 60 of the plunger 50 in the barrel 52. The seal 54 is insertable into the lower end of the barrel 52, and is made of a pliable material, such as a silicone rubber, that can seal against a windshield.

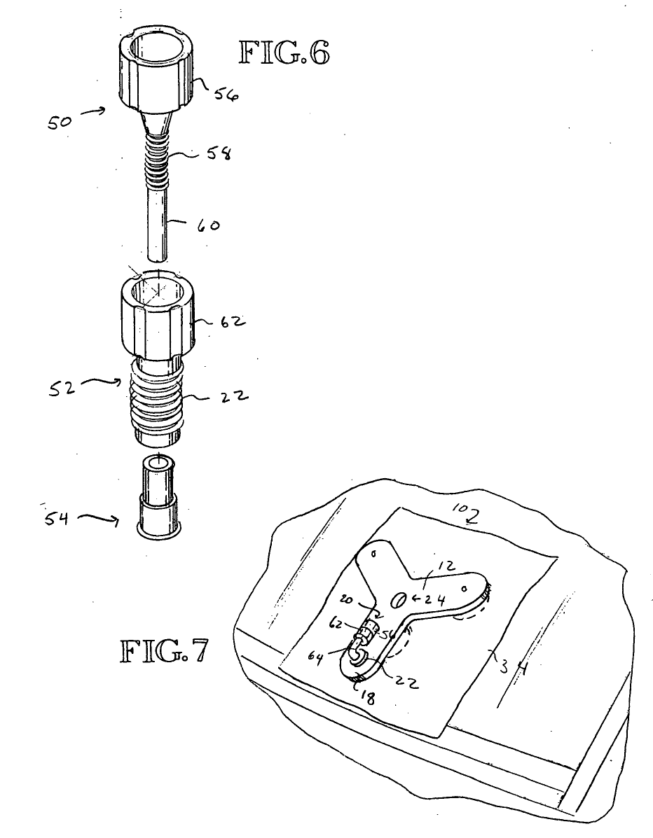

According to one embodiment of the invention, and as shown in FIG. 7, the resin applicator 20 may include an elongated, right-angle neck 64 between the cap 62 and threaded barrel 22 of the body 52. The right-angle neck allows the upper portion of the resin applicator to lie close to the plane of the base 12, thus providing an even lower profile of the windshield repair apparatus 10.

The windshield repair apparatus 10 may be used in the repair windshield damage by filling the resin applicator 20 with windshield repair resin and positioning the one of the apertures 24, 26 in the base 12 in which the resin applicator 20 is mounted over the defect to be repaired. The suction cups 28, 30, 32 maintain the base 12 in position on the windshield. The resin applicator may then be rotated to screw it into the base until the seal 54 is in sealing contact with the windshield. The cap 56 of the plunger may then be rotated to force resin out of the body 52 of the resin applicator and into the windshield defect. For most repairs, the center aperture 24 may be conveniently used. For repairs adjacent the edges of the windshield, however, it may be preferable to use the second aperture 26 that is adjacent the distal end of the arm 18.

The UV shield 34 protects the windshield from UV light that could cause the curing of the windshield repair resin before the application process is completed. This may be particularly important if windshield repair has to be interrupted to avoid interference with the completion of tasks by lube center personnel. As the UV shield may be made from a plastic material that is at least somewhat transparent to visible light, the shield 34 does not materially impair the windshield repair process.

Once the resin application process has been completed, the windshield repair apparatus 20 may be removed and a UV source 40 may be mounted to the windshield above the repair site. Light from the UV source 40 can then speed the curing of the resin.

The low-profile windshield repair apparatus 20 and UV light source 40 may be used in a process that allows the integration of windshield repair service with other automotive services, such as those offered by a lube center. In one embodiment, the method of the present invention may proceed in the following manner.

First, as vehicles come into the lube center, a windshield repair technician or manager (hereinafter referred to as the “technician”) may inspect the windshields to determine if they include reparable damage. If so, the driver of the vehicle is approached to determine whether he or she wishes to have the windshield defect repaired. This initial approach to the customer may have to be delayed until after the lube center greeter has taken the necessary information and instructions from the customer for the lube center servicing of the vehicle, as the windshield repair inquiries should be made without interfering with the vehicle intake process of the lube center. Thus, they may be undertaken either while the vehicle is awaiting the intake processing or after it is completed.

If it is initially determined that the insurance does not cover damage to windshields and the like, and if the vehicle operator still wishes to have the windshield repaired, a fee-for-service arrangement may be made with the vehicle operator prior to initiation of the windshield repair process.

If it appears that insurance coverage for the windshield repair may be available, the next step is to initiate the claim authorization process. This commences with the gathering of certain information, such as, for example, the name of the vehicle owner, the name of the insurance carrier for the vehicle, the policy number and the vehicle identification, such as the VIN and license plate number. Arrangements for or collection of a processing fee may also be made at this time, either as a simple fee in addition to any amount that the insurance company may pay or as a fee in return for a waiver of charges to the customer should the insurance claim be denied.

The technician then initiates vehicle insurance claim processing by calling the insurance carrier. In the present embodiment, a list of telephone numbers and access numbers may be provided to the technician to facilitate the dialing process. At present, most insurance companies use automated call answering systems, and the proper extension for vehicle insurance claim processing for windshield repair may be accessed by sequentially entering or speaking a series of access numbers to reach the extension. As an example, an automated telephone system may first require pressing “1” to select English, “2” to select Spanish, etc. A voice menu identifying different departments and corresponding dialing numbers may next be presented. After that, a menu may start regarding the type of claim, and so forth. A substantial amount of time and attention may thus be required to reach the proper extension. Many such systems, however, will receive an entered number before the voice message has played out. Thus, if the extension can be reached, for example, by pressing, in sequence and with proper timing, “1,” “3,” “2” and “4,” substantial time can be saved by skipping over the lengthy voice menus.

The telephone numbers and access codes for various of the insurance companies may be provided as on a laminated card or handheld electronic device, may be programmed into a telephone, such as a cordless or cellular telephone, or may be entered automatically with the assistance of an electronic device. Alternatively, a connected wireless or wired computing device may be used to connect to and transmit insurance claim processing information directly to insurance company computers.

A claims authorization script may also be used to facilitate the claims approval process as well as to assist in speeding and organizing the gathering of insurance claim information. Different insurance companies often require different information or require the information to be provided in a different order or using different terms. Having a script for submission of claims for windshield repair authorization can shorten the amount of time required for submission of the information, improve the accuracy and completeness of gathering and delivery of the information and reduce miscommunication with the customer's insurance carrier. For example, one insurance company may require the license plate number, vehicle identification number, the insured's name and address, the insurance policy identification number, and the like in that order and using those terms, while another may require policy number, first and last name of the insured, and other information in that order using that wording.

Thus, in one embodiment, the windshield repair process may proceed as follows, with windshield repair being initiated prior to receiving windshield repair claim authorization so that the lube center servicing of the vehicle, the insurance claim processing and the windshield repair may go forward in parallel.

The affected area of the windshield is first cleaned and prepared for repairing. If the damaged area includes pitting or chipping from the impact that produced the damage, a cordless rotary tool with a carbide or other bit may be used to drill into the affected area and remove loose material. This may also enhance the penetration of the resinous material into the damaged area of the windshield, and is part of the processing method that allows the repair to proceed without accessing the vehicle interior.

A low-profile windshield repair apparatus 10 such as those shown in FIGS. 1 and 7. A flexible UV light shield 34 may be mounted, directly or indirectly, on the base 16 of the windshield repair apparatus 10 to retard the curing of the resin. Such cure retardation may be particularly important where access to the vehicle must be suspended for a period to allow the lube center personnel to carry out their vehicle servicing tasks, to initiate or continue insurance claim processing for the present or other vehicle, and the like.

The resinous material may be extruded through the seal 54 of the applicator 20 that bears against the windshield to be repaired. Resinous material is forced into and flows through cracks in the glass of the damaged area. This flow may be assisted by flexing the windshield in the damaged area by application of a localized force from the outside of the vehicle, such as by applying and releasing pressure on the affected area with an instrument such as an awl, pick or probe, one or more times.

The aggressive working of the damaged area by the rotary tool and/or instrument and the use of low-profile, self-powered tools facilitates the windshield repair without access to the vehicle interior and with minimal impact on the other vehicle servicing being provided at the lube center. The aggressive working of the windshield may contribute to further window damage, however. Moreover, the windshield repair may or may not be successful. As such, if the window is further damaged during the repair process, arrangements may be made to either replace the windshield in a conventional manner outside the scope of the vehicle servicing at the lube center, either at no cost or at the cost of the customer or insurance company.

To further streamline the process and reduce the start-to-finish time required to fit with the timing of the lube center servicing of the vehicle, the technician performing the windshield repair may be equipped with a non-wired phone such as a cordless phone or cellular phone. Preferably, he or she is also equipped with a hands-free headset. In addition to allowing calls to the insurance companies, such a telephone permits the technician to receive calls from insurance companies in which they may request additional information or provide authorizations while the technician is working on the windshield repair. The phone may also be programmed to assist navigation of insurance company automated telephone systems as well as to access information from and provide information to a central windshield repair management center.

After approval, it is still necessary to complete the paperwork for processing of insurance claims. The technician may complete this paperwork, or the central windshield repair management center may receive information and assist in completion of the paperwork.

The present embodiments are for illustrative purposes only, and it will be appreciated by those skilled in the art that modifications may be made thereto within the scope of the invention.

We claim:

1. A method of repairing damaged vehicle windshields during vehicle servicing and without delaying windshield repair pending insurance claim approval comprising:
determining the insurance carrier for the vehicle being serviced;
navigating an automated telephone system of the insurance carrier according to the corresponding one of a plurality of automated telephone system access sequences previously provided for a plurality of insurance companies;
initiating the insurance claim authorization process for a windshield repair by providing insurance claim information to the insurance company using the corresponding one of a plurality of scripts for a plurality of insurance companies;
performing at least one of the windshield repair steps while awaiting insurance claim approval and while lube center vehicle servicing is being conducted, the windshield repair steps comprising:
applying a resinous material to a damage area of the windshield;
flexing the windshield from the exterior of the vehicle in the damage area
using a windshield flexing probe; and
mounting a self-powered UV light source on the windshield to provide UV light to cure the resinous material; and
accepting the claim authorization after commencing the repairing of the windshield.

2. The method of claim 1 wherein the application of the resinous material comprises the steps of:
affixing a low-profile resinous material dispenser to the windshield, the dispenser having a flexible, UV light shield mounted thereon; and
then applying the resinous material to the windshield.

3. The method of claim 1 wherein the windshield damage includes a pitting of the windshield, the method further comprising the step of removing glass from the pitting using a self-powered rotary tool prior to the step of applying the resinous material to the windshield.

4. The method of claim 1 wherein the windshield repair is completed using low-profile windshield repair apparatus.

5. The method of claim 1 wherein the steps of navigating an automated telephone system, initiating an insurance claim authorization process and accepting the claim authorization are performed using a hands-free phone.

6. The method of claim 1 further comprising the steps of charging an insurance claim processing fee corresponding to a minor portion of normal windshield repair charges and offering the windshield repair customer a repair charge waiver.

7. The method of claim 1 wherein the windshield repair steps are performed without entry into the vehicle by the windshield repairer.

8. A system for repairing damaged vehicle windshields during vehicle servicing, the vehicle including movable body parts adjacent to the windshield, the system comprising;
a low-profile base releasably mountable to a windshield;
a dispenser for resinous material mountable to said base for applying the resinous material to a vehicle windshield; and
a flexible UV light shield mounted to the base, the base, dispenser and shield being sufficiently low profile that they may be mounted on the windshield without interfering with the movement of the movable portion of the vehicle;
a self-powered, low-profile UV light source mountable on the windshield for providing UV light to the windshield upon removal of the flexible UV light shield;
an automated telephone system access sequence for each of a plurality of insurance carriers; and
a windshield claim authorization scripts for each of a plurality of insurance carriers, whereby the telephone system of a selected insurance carrier may be accessed and insurance claim information may be provided to the selected insurance carrier during windshield repair.

9. The system of claim 8 further comprising a resinous windshield repair material.

10. The system of claim 9 wherein the resinous material includes a minor portion of a tinting agent.

11. A method of repairing a vehicle windshield having a damage area without entering the vehicle comprising the steps of:
collecting vehicle insurance information and initiating vehicle insurance claim processing using an insurance-carrier-specific dialing sequence and an insurance-carrier-specific script;
while vehicle insurance claim processing is proceeding, applying a resinous material to the damage area of the windshield using a low-profile applicator mounted on a base, the base being releasably mountable to the windshield, and simultaneously shielding the damage area from UV light using a low-profile, flexible UV light shield mounted to the base;
removing the applicator and UV light shield;
exposing the damage area to a self-powered, low-profile UV light source;
at least one of the foregoing steps of applying the resinous material, removing the applicator and UV light shield and exposing the damaged area to the UV light source being performed during lube center servicing of the vehicle by lube center personnel, and all of such steps being performed without entering the vehicle.

11. The method of claim 11 further comprising the steps of applying pressure to the windshield using a windshield repair probe after application of the resinous material.

12. The method of claim 11 wherein the damage area includes a pitting in the windshield and wherein the method further comprising the step of using a self-powered rotary tool to remove glass from the pitting before application of the resinous material.

13. The method of claim 11 wherein the resinous material contains a tinting material.

14. The method of claim 13 wherein the tinting material provides a greenish hue to the resinous material.

15. The method of claim 11 further comprising the step of charging an initial processing fee for processing a windshield repair insurance claim, and wherein, if the insurance claim is rejected subsequent to commencement of the application of the resinous material, the windshield repair is completed without further charge.

16. The method of claim 11 further comprising the step of removing excess resinous material from the repaired area of the windshield.
